(19) United States
(12) Patent Application Publication
(10) Pub. No.: US 2023/0092466 A1
(43) Pub. Date: Mar. 23, 2023

(54) DETERMINING FUTURE SWITCHING BEHAVIOR OF A SYSTEM UNIT

(71) Applicant: Yunex GmbH, München (DE)

(72) Inventors: Michel Tokic, Tettnang (DE); Stefan Depeweg, München (DE); Steffen Udluft, Eichenau (DE); Markus Kaiser, München (DE); Daniel Hein, München (DE)

(21) Appl. No.: 17/909,044

(22) PCT Filed: Jan. 21, 2021
(86) PCT No.: PCT/EP2021/051302

§ 371 Date: Sep. 2, 2022

(30) Foreign Application Priority Data
Mar. 2, 2020 (DE) 10 2020 202 656.4

(51) Int. Cl. G06N 3/04; G06N 3/08; G08G 1/01; G08G 1/095

(52) U.S. Cl. CPC G06N 3/04; G06N 3/08; G08G 1/0104; G08G 1/095

(57) ABSTRACT

A computer-implemented method for configuring a system model and a computer-implemented method for configuring a sensor model. There is also described a computer-implemented method for determining future switching behavior of a system unit, with the following steps: a) receiving the configured system model; b) receiving the configured sensor model, c) the configured sensor model being a probability distribution regarding how the sensor unit will behave in the specific time period; d) establishing at least one random sample of behavior of a sensor unit by sampling from the probability distribution; and e) determining the future switching behavior of the system unit and/or at least one associated statistical value on the basis of the established random sample by means of the trained system model. There is also described a corresponding computer program product.

### 1. TECHNICAL FIELD

The invention relates to a computer-implemented method for configuring a system model and to a computer-implemented method for configuring a sensor model.

The invention furthermore relates to a computer-implemented method for determining future switching behavior of a system unit. The invention is likewise directed to a corresponding computer program product.

### 2. PRIOR ART

Light signaling systems are already known from the prior art. The light signaling systems are usually used in the public sphere for traffic control. The light signaling system may comprise detectors, signal groups and controllers for control purposes. The detectors are also referred to hereinafter as sensor units.

Signal images of a signal group (red/amber/green) are typically controlled by the controller. The light signaling system may switch over or change from one operating state to another operating state at the switchover time, for example from a green light to a red light. In other words, a signal change takes place at the switchover time. In the case of “green”, a road user may assume that proceeding in the corresponding traffic direction is allowed.

With regard to the light signaling systems, various items of information or signal-related data are relevant. The data comprise for example the remaining time, i.e. the time duration until the next switchover, also called switchover time, of the light signaling system and a probability distribution of the states of the light signaling system, such as signal groups in the future. These data are required for the reduction of braking and starting processes and routing of the road users in traffic.

Often, however, the remaining time or probability of green is not passed on or is not passed on sufficiently outwardly to the road users by the light signaling system. Furthermore, the remaining time is often not known since it is dependent on the traffic flow, the behavior of the road users or other factors.

A forecast that is as reliable and accurate as possible is required in these cases. An AI (“Artificial Intelligence”) that provides the forecast should satisfy the following criteria:

Interpretability and transparency: the predefined and learned portions of the AI should be understandable and comprehensible to human experts, in particular for validation and supervision of the solution found.

The uncertainty in the forecast should be modeled in order to be able to weigh up decision problems, such as routing and speed control of the vehicles.

The hierarchical process as to how a change in the state of signal groups is triggered should be simulated as accurately and correctly as possible in an AI.

Furthermore, expert knowledge about the switching behavior of a light signaling system should be taken into account in the modeling process.

Previous solution approaches in accordance with the prior art are based on established machine learning models, such as neural networks and random forests. These models carry out a forecast of the remaining time or probability of a green light on the basis of the given signals of the detectors, the signal groups, the public transport messages, the camera signals and/or other known data. These models are also referred to as black box methods. Their inner structure is suitable for approximating any desired functions. In other words, these methods map a direct relationship from input variables to output variables.

What is disadvantageous about these methods, however, is that they do not sufficiently model the actual hierarchical process. Therefore, adaptation to a given problem is not possible with these conventional methods. Furthermore, these methods do not satisfy the abovementioned criteria, such as interpretability. By way of example, it is not clear or comprehensible whether an erroneous forecast of the remaining time results on account of inadequate modeling of the switching behavior of the light signaling system or from an inadequate forecast of future detector signals. In other words, the cause of errors cannot be established efficiently and reliably. Furthermore, the expert knowledge may concomitantly influence the forecast to an inadequate extent.

The present invention therefore addresses the objective technical problem of providing a method for determining future switching behavior of a system unit which is more reliable and more efficient.

### 3. SUMMARY OF THE INVENTION

The problem mentioned above is solved according to the invention by means of a computer-implemented method for configuring a system model, wherein the system model is a machine learning model for determining switching behavior of a system unit, comprising the following steps:
a. providing at least one training data set comprising a plurality of known input elements of the system unit for in each case a specific point in time or time period; wherein
b. the plurality of known input elements of the system unit comprises at least one sensor data set of a sensor unit;
c. configuring the system model by means of a machine learning method using the at least one training data set; and
d. providing the configured system model as output.

In one embodiment, the machine learning method is a rule-based approach, selected from the group consisting of:

neural network and decision tree.

Accordingly, the invention is directed to a method for configuring a system model. The system may be a light signaling system or some other system in the field of traffic. The term configuring may be interpreted in the sense of learning or else training in the context of machine learning. The system model is a machine learning model.

In a first step, the training data set comprising the input elements is received. The training data set may be received via one or more interfaces of an arbitrary computing unit. In other words, a series or array comprising known input elements is considered. In this context, known means that the input elements were gathered or obtained for example from road users from the past in traffic. Consequently, they are historical data.

Said input elements relate to the system unit and comprise at least one sensor data set. The sensor data set may comprise signals of a sensor unit for a specific time period. The sensor unit may be formed as a detector unit. In this case, the detector signals of the last t-T seconds may be considered, where t is a running index and T is the number of seconds considered. T may be 30 seconds, for example, where T=30. In other words, the concrete and actual behavior of the sensor unit is employed for the further steps. This may be represented as follows: t−30, . . . , t−1→t.

In further steps, the system model, which is a machine learning model, is configured on the basis of the training data set and is provided as output. In this case, the machine learning method is a rule-based approach in order to determine the deterministic switching behavior of the system unit. In the exemplary case of a decision tree, the switching behavior may be derived in the form of a rule.

The invention furthermore relates to a computer-implemented method for configuring a sensor model, wherein the sensor model is a machine learning model for determining behavior of a sensor unit, comprising the following steps:
a. providing at least one training data set comprising a plurality of known input elements of a sensor unit for in each case a specific point in time or time period; wherein
b. the plurality of known input elements of the sensor unit comprises at least one sensor data set for a specific point in time;
c. configuring the sensor model by means of a machine learning method using the at least one training data set; wherein
d. the configured sensor model is a probability distribution regarding how the sensor unit will behave in the specific time period;
e. providing the configured sensor model as output.

In one embodiment, the machine learning method is a stochastic approach, preferably a Poisson process.

Accordingly, the invention is directed to a method for configuring a sensor model. The sensor unit may be formed as a detector unit or detector. The term configuring may be interpreted in the sense of learning or else training in the context of machine learning. The sensor model is a machine learning model.

In a first step, the training data set comprising the input elements is received; these are also historical data, see further above. However, said input elements relate to the sensor unit itself and comprise at least one sensor data set, such as the state of the detector unit.

In further steps, the sensor model, which is a machine learning model, is configured on the basis of the training data set and is provided as output. In this case, the machine learning method is a stochastic approach in order to determine the stochastic detector behavior and thus a probability distribution regarding how the detectors will behave in the next 30 seconds, for example. In other words, a forecast is created, for example of t→t+1, . . . , t+30.

The invention furthermore relates to a computer-implemented method for determining future switching behavior of a system unit, comprising the following steps:
a. receiving the configured system model;
b. receiving the configured sensor model; wherein
c. the configured sensor model is a probability distribution regarding how the sensor unit will behave in the specific time period;
d. ascertaining at least one random sample of behavior of a sensor unit by means of sampling from the probability distribution;
e. determining the future switching behavior of the system unit and/or at least one associated statistical value with the aid of the trained system model on the basis of the at least one ascertained random sample.

The future switching behavior of the system unit may be determined by combination of the two different configured models by a procedure in which
the configured sensor model is evaluated in order to obtain a distribution of the sensor unit over the next T, e.g. 30, seconds,
a sample (synonymous with a trajectory) representing a possible realization of the next T=30 seconds is taken from this distribution and this realization of the sensor unit is translated into the switching behavior of the system unit with the aid of the system model and these steps are repeated until there are enough realizations to be able to make a statistical statement. The statistical value is determined in step e.

In one embodiment, the statistical value is selected from the group consisting of median, mean and variance.

In one embodiment, the method furthermore comprises the following step:
carrying out a measure, wherein the measure is selected from the group consisting of:
   outputting the future switching behavior of the system unit and/or at least one associated statistical value on a display unit,
   storing the future switching behavior of the system unit and/or at least one associated statistical value in a storage unit, and
   communicating the future switching behavior of the system unit and/or at least one associated statistical value to a computing unit.

Accordingly, it is possible to initiate one or more measures following the prediction of the future switching behavior of the system unit. The measures may be carried out simultaneously, successively or else in a stepwise manner.

First, the output data set may be displayed to the user on a display unit of a computing unit. Furthermore, the output data set may be stored or be transmitted in the form of a corresponding message or notification to another unit, such as a terminal, a control unit or other computing unit. The receiving computing unit may likewise initiate further corresponding measures after reception. Further measures are route planning, starting an engine of a vehicle or other vehicle control measures. The information of the switching behavior may advantageously be used for example for reducing braking and starting processes and also routing.

By way of example, the computing unit of a vehicle may receive the output data set and trigger a control measure depending on the reliability value of the median.

The invention furthermore relates to a computer program product comprising a computer program which comprises means for carrying out the above-described method when the computer program is executed on a program-controlled device.

A computer program product, such as e.g. a computer program means, may be provided or supplied for example as a storage medium, such as e.g. memory card, USB stick, CD-ROM, DVD, or else in the form of a downloadable file from a server in a network. This may be done for example in a wireless communication network by way of the transmission of a corresponding file comprising the computer program product or the computer program means. An appropriate program-controlled device is in particular a control device such as, for example, an industrial control PC or a programmable logic controller, PLC for short, or a microprocessor for a smartcard or the like.

### 4. BRIEF DESCRIPTION OF THE DRAWINGS

Presently preferred embodiments of the invention are described further in the following detailed description with reference to the following FIGURES.

FIG. 1 shows an exemplary detector trajectory.

### 5. DESCRIPTION OF THE PREFERRED EMBODIMENTS

Preferred embodiments of the present invention are described below with reference to the FIGURE.

### Method for Configuring a System Model (Deterministic Switching Behavior)

In accordance with one embodiment of the invention, the internal deterministic switching behavior of a light signaling system as system unit is approximated with the aid of a mathematical or logical function as decision tree. In the approximation it is assumed that the true or actual switching behavior of the light signaling system is unknown. However, the switching behavior follows fixed rules, for example as a schematic circuit diagram for the intelligent logic module from Siemens “LOGO”. What rules are possible is furthermore known. These permissible rules of control of the light signaling system are represented as a decision tree. The search for the internal deterministic switching behavior of the light signaling system is realized by generating decision trees that may explain the historical data as accurately as possible.

In this case, it is possible to use evolutionary or particle-based optimization methods for searching in these symbolic search spaces. The permissible rules are modeled as function blocks and are interconnected, tested and improved by the optimization methods. Both evolutionary and particle-based optimization methods consider generations of possible solutions. In this case, the best solutions of a parent generation preferably pass on information to the child generation thereof, such that the entire population becomes successful over time.

Given the training data set comprising input elements such as e.g. the sensor signals of the last t-T seconds, the instantaneous signal plan (as index) at the point in time t, the state of the SGR (“signal group”) of the last t-T seconds, the current state of all SGRs (“signal groups”) is calculated. In other words, the deterministic switching behavior of the light signaling system is represented given the context. Consequently, the input elements may also be referred to as context features.

### Method for Configuring a Sensor Model (Stochastic Detector Behavior)

In contrast to the deterministic switching behavior, the behavior of the sensor units of a light signaling system is not predetermined by deterministic rules, but rather is dependent on environmental influences.

By way of example, it is not possible to predict when the pushbutton of a pedestrian crossing light will be actuated.

This is owing to the fact that it is not known when a pedestrian will arrive at the crossing light. However, historical data can be used to learn how often a pedestrian should be expected. By way of example, in the evening approximately 2 pedestrians per 5 minutes may be expected at a light signaling system.

Traffic-situational signals such as detectors and local public transport (public transport messages) are therefore modeled as a stochastic process, e.g. as a Poisson process. Given the training data set comprising input elements such as e.g. calendar data (time of day, weekday, holiday), detector states, public transport of the last T seconds, this process forecasts a probability distribution regarding detectors and public transport for a horizon of the coming H seconds (e.g. 5 minutes). In other words, the stochastic switching behavior of the detectors is determined given the context. Consequently, the input elements may also be referred to as context features.

In accordance with one embodiment of the invention, the probability distribution is modeled in the form of the parameters of a Poisson distribution. A Bayesian method, in particular a Gaussian process or a Bayesian neural network, is used as a regressor that forecasts the parameters of the Poisson distribution from the context. A stochastic process is modeled by way of the forecast of the parameters of a Poisson distribution with the aid of a Bayesian method. This stochastic process cannot explicitly predict the point in time of the next detector actuation in reality. Instead, it is possible to calculate statistics regarding the actuation (e.g. mean waiting time for the next actuation, variance or quantiles of this waiting time) or to take random samples. Such random samples are used for forecasting.

### Method for Determining Future Switching Behavior of a System Unit (Forecast by Means of Rollouts)

Since the behavior of the detectors cannot be predicted exactly, an exact prediction of the switching behavior of the system unit in the future is not possible either. Instead, the distribution of possible switching behaviors of the light signaling system in the future is predicted. Statistics may be calculated from this distribution. The distribution of possible switching behaviors is generated by means of probabilistic rollouts that take account of the multiplicity of possible developments in the future. The rollouts are generated as follows:

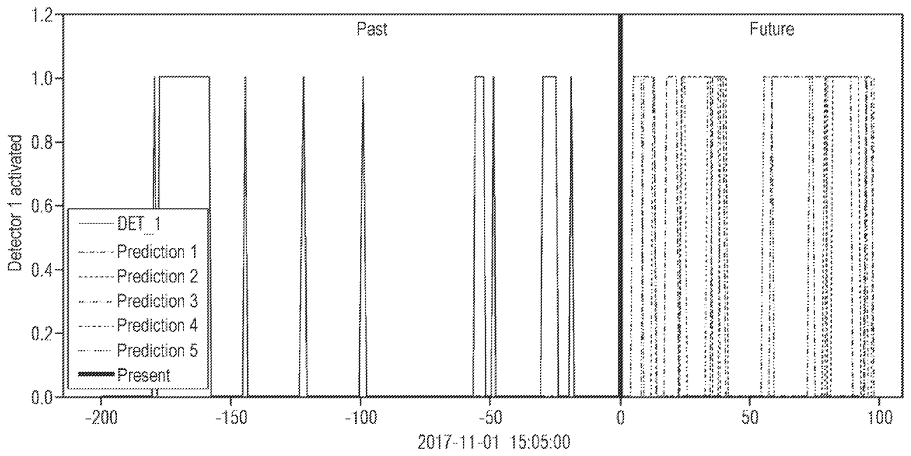

1. Sampling of detector trajectories from the stochastic detector model. An exemplary detector trajectory is shown in FIG. 1.

2. Sampling of signal group trajectories/development of the crossing light model with detector trajectories from step (1).

3. Calculation of relevant statistics from the signal group trajectories, e.g. median (forecast), variance (uncertainty). Optionally, the entire architecture, in particular the stochastic model, may additionally be trained directly with regard to the forecast quality. For this purpose, the error signal of the forecast (e.g. of the remaining time) is backpropagated through the symbolic model (step 1) and then further to the parameters of the stochastic model (step 2). Focusing of the learning may be achieved as a result: importance is attached particularly to the stochastic patterns of the DET/OEV signals during training, which are also important for the forecast of the remaining time.

1-8. (canceled)

9. A computer-implemented method for configuring a system model, the system model being a machine learning model for determining a switching behavior of a system unit, the method comprising:
a. providing at least one training data set with a plurality of known input elements of the system unit, in each case for a specific point in time or time period; wherein
b. the plurality of known input elements of the system unit includes at least one sensor data set of a sensor unit;
c. configuring the system model by a machine learning method using the at least one training data set; and
d. providing the configured system model as output.

10. The computer-implemented method according to claim 9, wherein the machine learning method is a rule-based approach, selected from the group consisting of: neural network and decision tree.

11. A computer-implemented method for configuring a sensor model, the sensor model being a machine learning model for determining a behavior of a sensor unit, the method comprising:
a. providing at least one training data set with a plurality of known input elements of a sensor unit, in each case for a specific point in time or time period; wherein
b. the plurality of known input elements of the sensor unit includes at least one sensor data set for a specific point in time;
c. configuring the sensor model by a machine learning method using the at least one training data set; wherein
d. the configured sensor model is a probability distribution regarding how the sensor unit will behave in the specific time period; and
e. providing the configured sensor model as output.

12. The computer-implemented method according to claim 11, wherein the machine learning method is a stochastic approach.

13. The computer-implemented method according to claim 12, wherein the machine learning method is a Poisson process.

14. A computer-implemented method for determining future switching behavior of a system unit, the method comprising:
a. receiving a configured system model, the system model being a machine learning model for determining a switching behavior of a system unit and the system model being configured by a computer-implemented method which includes the following:
a1. providing at least one training data set with a plurality of known input elements of the system unit, in each case for a specific point in time or time period; wherein
a2. the plurality of known input elements of the system unit includes at least one sensor data set of a sensor unit;
a3. configuring the system model by a machine learning method using the at least one training data set;
b. receiving a configured sensor model, the sensor model being a machine learning model for determining a behavior of a sensor unit and the sensor model being configured by a computer-implemented method which includes the following:
b1. providing at least one training data set with a plurality of known input elements of a sensor unit, in each case for a specific point in time or time period; wherein
b2. the plurality of known input elements of the sensor unit includes at least one sensor data set for a specific point in time;
b3. configuring the sensor model by a machine learning method using the at least one training data set; wherein
b4. the configured sensor model is a probability distribution regarding how the sensor unit will behave in the specific time period;
c. ascertaining at least one random sample of a behavior of a sensor unit by sampling from the probability distribution; and
d. determining the future switching behavior of the system unit and/or at least one associated statistical value with the aid of the trained system model based on the ascertained random sample.

15. The computer-implemented method according to claim 14, wherein the statistical value is selected from the group consisting of median, mean, and variance.

16. The computer-implemented method according to claim 14, further comprising:
carrying out a step selected from the group consisting of:
outputting a future switching behavior of the system unit and/or at least one associated statistical value on a display unit;
storing the future switching behavior of the system unit and/or at least one associated statistical value in a storage unit; and
communicating the future switching behavior of the system unit and/or at least one associated statistical value to a computing unit.

17. A computer program product comprising a computer program with program code for carrying out the method according to claim 9 when the computer program is executed on a program-controlled device.
